(19) United States
(12) Patent Application Publication
(10) Pub. No.: US 2002/0004542 A1
(43) Pub. Date: Jan. 10, 2002

(54) Ignition resistant monovinylidene aromatic copolymer composition

(76) Inventor: Samuel A. Ogoe, Missouri City, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/776,992

(22) Filed: Feb. 5, 2001

Related U.S. Application Data
(60) Provisional application No. 60/191,945, filed on Mar. 24, 2000.

(51) Int. Cl. C08K 5/10; C08K 5/38; C08K 5/48; C08K 3/18; C08K 3/22

(52) U.S. Cl. 524/281; 524/287; 524/520; 524/515

(57) ABSTRACT

Disclosed is a monovinylidene aromatic copolymer composition comprising a combination of monovinylidene aromatic copolymers, a flame retardant, an optional flame retardant synergist and a drip suppressant, wherein the combination of monovinylidene aromatic copolymers comprise a mass polymerized, rubber-modified monovinylidene aromatic copolymer and an emulsion polymerized, rubber-modified monovinylidene aromatic copolymer. Said compositions have a good balance of physical properties and are rated V-2, V-1, V-0 and/or 5V in the Underwriter's Laboratories Standard 94 flammability test.

### CROSS REFERENCE STATEMENT

This application claims the benefit of U.S. Provisional Application No. 60/191,945, filed Mar. 24, 2000.

### FIELD OF THE INVENTION

This invention relates to a monovinylidene aromatic copolymer composition comprising a combination of monovinylidene aromatic copolymers, a flame retardant, an optional flame retardant synergist and a drip suppressant. This invention relates particularly to a monovinylidene aromatic copolymer composition comprising a combination of a mass polymerized, rubber-modified monovinylidene aromatic copolymer and an emulsion polymerized, rubber-modified monovinylidene aromatic copolymer having a good balance of physical properties and rated V-2, V-1, V-0 and/or 5V in the Underwriter's Laboratories Standard 94 flammability test.

### BACKGROUND OF THE INVENTION

Monovinylidene aromatic copolymers such as acrylonitrile, butadiene, and styrene copolymers (ABS) have been previously admixed with flame retardant additives and drip suppressants, see U.S. Pat. No. 4,107,232; U.S. Pat. No. 4,639,486; U.S. Pat. No. 4,579,906; and U.S. Pat. No. 5,539,036 all of which are incorporated herein by reference. Flame retardants have included materials such as phosphorous containing compounds and/or brominated compounds, and drip suppressants have included such compounds as halogenated polyolefins such as chlorinated polyethylene and tetrafluoroethylene. Generally compositions containing chlorinated polyethylene demonstrate poor thermal stability and have required the presence of a metal stabilizer such as a tin (Sn) and/or an epoxy containing compound. Thermal instability in compositions containing chlorinated polyethylene often results in polymer degradation during fabricating processes, such as injection molding, causing black specs in articles thus produced. Furthermore, these compounds have at times experienced undesirable levels of blooming of the various additives to the surface of the molded articles made therefrom. Black specs and/or blooming results in molded articles with unacceptable surface appearance. Further, build-up of additives on the mold surface of the injection molding machine is costly because of down-time required for cleaning. Drip suppressants have also included tetrafluoroethylene, but effective levels have adversely effected practical toughness, i.e., impact strength properties.

Accordingly, there is a need for an monovinylidene aromatic copolymer composition containing a monovinylidene aromatic polymer, a flame retardant and a drip suppressant which exhibit a good balance of ignition resistance, low levels of blooming and good practical toughness.

### SUMMARY OF THE INVENTION

It has surprisingly now been found that it is possible to impart ignition resistance to a polymer composition, comprising a combination of monovinylidene aromatic copolymers, the combination comprising a mass polymerized, rubber-modified copolymer, an emulsion polymerized, rubber-modified copolymer and optionally a monovinylidene aromatic copolymer; an effective amount of a flame retardant compound; optionally a synergist; and a drip suppressant. Said monovinylidene aromatic copolymer composition having a good balance of physical properties including impact strength resistance is rated V-2, V-1, V-0 and/or 5V in the Underwriter's Laboratories Standard 94 flammability test.

In another aspect, the present invention is a process for preparing the abovementioned monovinylidene aromatic copolymer composition by admixing a mass polymerized, rubber-modified copolymer, an emulsion polymerized, rubber-modified copolymer, optionally a monovinylidene aromatic copolymer, an effective amount of a flame retardant compound, optionally a synergist and a drip suppressant.

In a further aspect, the present invention involves a method of molding or extruding the abovementioned monovinylidene aromatic copolymer composition comprising a mass polymerized, rubber-modified copolymer, an emulsion polymerized, rubber-modified copolymer, optionally a monovinylidene aromatic copolymer, an effective amount of a flame retardant compound, optionally a synergist and a drip suppressant.

In yet a further aspect, the invention involves molded or extruded articles of the abovementioned monovinylidene aromatic copolymer composition comprising a mass polymerized, rubber-modified copolymer, an emulsion polymerized, rubber-modified copolymer, optionally a monovinylidene aromatic copolymer, an effective amount of a flame retardant compound, optionally a synergist and a drip suppressant.

The monovinylidene aromatic copolymer compositions of the present invention are especially useful in the preparation of molded objects notably parts required to meet UL 94 V-2 rating or better. These compositions are particularly suited for use in instrument housings such as for power tools, appliances, consumer electronic equipment such as TVs, VCRs, web appliances, electronic books, etc., or information technology equipment such as telephones, computers, monitors, fax machines, battery chargers, scanners, copiers, printers, hand held computers, etc.

### DETAILED DESCRIPTION OF THE EMBODIMENTS

Component (a) comprises a combination of monovinylidene aromatic copolymers which are rubber modified (a1) and (a2) and optionally a non-rubber modified monovinylidene aromatic copolymer (a3). For all described components (a1, a2 and a3), suitable monovinylidene aromatic monomer constituents include styrene, alkyl-substituted styrenes such as alpha-alkylstyrene (e.g., alpha-methylstyrene, alpha-ethylstyrene etc.), various ring-substituted styrenes such as para-methylstyrene, ortho-ethylstyrene, 2,4dimethylstyrene, etc., ring-substituted halo-styrenes such as chloro-styrene, 2,4-dichloro-styrene, and the like. Styrene is the preferred monovinylidene aromatic monomer. The monovinylidene aromatic monomer (especially styrene) typically constitutes from about 55 to about 99 weight percent of said monovinylidene aromatic copolymer, preferably from about 60 to about 95 and more preferably from about 65 to about 90 weight percent thereof. Such monovinylidene aromatic copolymers are normally solid, hard (i.e., nonelastomeric) materials having a glass transition temperature in excess of 250° C. Mixtures of these monomers can be employed.

Suitable relatively polar comonomers for use as the minor constituent in (i.e., constituting from about 1 to about 45 weight percent of) the indicated monovinylidene aromatic copolymers include ethylenically unsaturated nitrites such as acrylonitrile, methacrylonitrile, ethacrylonitrile, etc.; ethylenically unsaturated anhydrides such as maleic anhydride; ethylenically unsaturated amides such as acrylamide, methacrylamide, etc.; esters (especially lower, e.g., C₁-C₆, alkyl esters) of ethylenically unsaturated carboxylic acids such as methyl methacrylate, ethylacrylate, hydroxyethylacrylate, n-butyl acrylate or methacrylate, 2-ethyl-hexylacrylate, etc.; ethylenically unsaturated dicarboxylic acid imides such as N-alkyl or N-aryl maleimides such as N-phenyl maleimide, etc. Especially preferred for use as the relative polar comonomer ingredient herein are the aforementioned ethylenically unsaturated nitriles. Preferably, these relatively polar comonomers or mixtures thereof constitute from about 5 to about 40 weight percent of the indicated monovinylidene aromatic copolymer, and most preferably 10 to 35 percent. Copolymer, as used herein, is defined as a polymer having two or more monomers interpolymerized. These compositions are generically known as SAN-type or SAN since poly(styrene-acrylonitrile) is the most common example.

The monovinylidene aromatic copolymer compositions have two or more components (e.g., a1 and a2) wherein the monovinylidene aromatic copolymers are rubber modified, e.g. having dispersed particles of a rubbery polymer with a glass transition temperature of 0° C. or lower. Especially preferred rubbery polymers for use herein are those having a glass transition temperature of −20 ° C. or lower. Examples of suitable such rubbery polymers include homopolymers of 1,3-conjugated alkadiene monomers; copolymers of from about 60 to about 99 weight percent of said 1,3-conjugated alkadienes with from about 1 to about 40 weight percent of a monoethylenically unsaturated monomer such as, for example, monovinylidene aromatic monomers (e.g., styrene, etc.) and ethylenically unsaturated nitrites such as acrylonitrile, methacrylonitrile etc.; ethylene/propylene copolymer rubbers; and ethylene/propylene/non-conjugated diene copolymers. Especially preferred rubbery polymers for use herein include polymers composed of from about 60 to 100 weight percent of 1,3-butadiene and from 0 to about 40 weight percent of styrene or acrylonitrile.

Rubber-modified copolymers, such as ABS, consist of a rigid matrix or continuous phase having dispersed therein particles of the elastomer, such particles usually having grafted thereto amounts of the rigid copolymer.

Component (a1) includes rubber-modified monovinylidene aromatic copolymers produced via mass or mass-suspension techniques, resulting in grafted rubber particles which have a portion of the rigid copolymer occluded in the rubber phase. The rubber types described above are present in an amount of from about 1 to about 40 weight percent, preferably 3 to 25 weight percent, and most preferably 5 to 20 weight percent. The rubber particles generally have a volume average particle size of from about 0.4 to about 10 micron. Mass or bulk polymerized rubber-modified monovinylidene aromatic copolymers are commercially available and are known to those skilled in the art. See, for example, U.S. Pat. Nos. 3,243,481; 3,509,237; 3,660,535; 4,221,833 and 4,239,863, the teachings of which are incorporated herein by reference.

Component (a2) includes rubber-modified monovinylidene aromatic copolymers in which the rubber particles are produced via emulsion techniques. At least a portion of the rubber particles is grafted to the matrix copolymer. The rubber types described above advantageously are present in amounts of from about 10 to about 85 weight percent, preferably from about 20 to about 75 weight percent, and more preferably from about 35 to about 60 weight percent. The rubber particles generally have a volume average particle size of from about 0.05 to about 5 micron.

Under most circumstances, emulsion polymerization techniques are generally economically feasible for the production of rubber particles having diameters less than about 0.25 micron. Such particles must usually be agglomerated or coagulated in some way before, during and/or after grafting in order to achieve rubber particles having diameters greater than about 0.5 micron. Agglomerating and coagulating techniques are well known in the art. See, for example, U.S. Pat. Nos. 3,551,370; 3,666,704; 3,956,218 and 3,825,621; all of which are incorporated herein by reference. A particularly desirable technique for the controlled agglomeration of the particles of an emulsion-prepared rubber in an aqueous dispersion is taught in U.S. Pat. No. 4,419,496, which is incorporated herein by reference.

Emulsion polymerized monovinylidene aromatic copolymers are commercially available, and preferably are in the form of butadiene rubber particles grafted with a mixture of styrene and acrylonitrile (SAN), and having a relatively high (greater than 20 percent) rubber content. These rubber-reinforced copolymers can be prepared using techniques known to those skilled in the art and including, for example, the method taught in U.S. Pat. No. 3,130,177, the teachings of which are incorporated herein by reference.

The (a) monovinylidene aromatic copolymer composition comprises a combination of monovinylidene aromatic copolymers, including (a1) from about 1 to about 99 weight percent of a mass polymerized rubber-modified copolymer; (a2) from about 99 to about 1 weight percent of an emulsion polymerized rubber-modified copolymer; and (a3) from 0 to about 98 weight percent of a monovinylidene aromatic copolymer, weight percents based on the total weight of component (a). Preferably, the (a) monovinylidene aromatic copolymer composition comprises a combination of monovinylidene aromatic copolymers, including (al) from about 5 to about 95 weight percent of a mass polymerized rubber-modified copolymer; (a2) from about 95 to about 5 weight percent of an emulsion polymerized rubber-modified copolymer; and (a3) from 0 to about 90 weight percent of a monovinylidene aromatic copolymer, weight percents based on the total weight of component (a). More preferably, the (a) monovinylidene aromatic copolymer composition comprises a combination of monovinylidene aromatic copolymers, including (a1) from about 10 to about 90 weight percent of a mass polymerized rubber-modified copolymer; (a2) from about 90 to about 10 weight percent of an emulsion polymerized rubber-modified copolymer; and (a3) from 0 to about 80 weight percent of a monovinylidene aromatic copolymer, weight percents based on the total weight of component (a). Most preferably, the (a) monovinylidene aromatic copolymer composition comprises a combination of monovinylidene aromatic copolymers, including (a1) from about 20 to about 80 weight percent of a mass polymerized rubber-modified copolymer; (a2) from about 80 to about 20 weight percent of an emulsion polymerized rubber-modified copolymer; and (a3) from 0 to about 60 weight percent of a monovinylidene aromatic copolymer, weight percents based on the total weight of component (a).

Component (a) is employed in the monovinylidene aromatic copolymer compositions of the present invention in amounts of at least about 50 weight percent, preferably at least about 70 weight percent, more preferably at least about 75 weight percent, even more preferably at least about 80 weight percent and most preferably at least about 85 weight percent based on the weight of the monovinylidene aromatic copolymer composition. In general component (a) is used in amounts less than or equal to about 98.99 weight percent, preferably less than or equal to about 95 weight percent, more preferably less than or equal to about 90 weight percent, and most preferably less than or equal to about 85 weight percent based on the weight of the monovinylidene aromatic copolymer composition.

A single flame retardant compound or a mixture of two or more individual flame retardant compounds may be used as component (b). Phosphorous and/or bromine containing compounds are preferred. For example, monomeric, oligomeric and/or polymeric organophosphorous containing flame retardant compounds useful in the present invention are disclosed in U.S. Pat. Nos. 4,355,126; 5,061,745; 5,204,394 and 5,672,645 and EP-345,522 and EP-363,608, which are incorporated herein by reference. Preferred organophosphorous containing flame retardant compounds are triphenyl phosphate, phenylene-bis(diphenylphosphate), phenylene-bis(dicresylphosphate), phenylene-bis(dixylylphosphate), bisphenol-A-bis(diphenylphosphate), bis phenol A-bis(dicresylphosphate), bis phenol A-bis(dixylylphosphate), or mixtures thereof.

Bromine containing flame retardant compounds useful in the present invention are disclosed in U.S. Pat. Nos. 4,355,126 and 5,539,036, which are incorporated herein by reference. Preferred examples of brominated compounds are octabromodiphenyl ethers, tetrabromophthalimide, tribromphenoxymethane, bis(tribromophenoxy)ethane, tris(tribromophenyl) triphosphate, trichlorotetrabromotoluene, hexabromocyclododecane and decabromodiphenyl ether.

More preferred bromine containing compounds are poly or oligomeric brominated compounds such as disclosed in U.S. Pat. Nos. 5,276,078 and 5,350,802. Most preferred brominated compounds are brominated polycarbonate oligomers and brominated epoxy oligomers. Especially preferred brominated compounds are brominated bisphenol-A polycarbonate oligomers and brominated bisphenol-A epoxy oligomers. Brominated epoxy oligomer compounds may be partially or completely capped, preferably with phenol, di(tertiarybutyl) phenol, brominated phenol, especially tribromophenol, phthalimide, or the likes.

These halogenated epoxy compounds are generally known in the art and are prepared by the coupling of epichlorohydrin and one or more diphenolic compounds or by the reaction of the appropriate diphenolic with an excess of the diglycidyl ether of the diphenolic compound. Suitable diphenolic compounds include tetrabromobisphenol A. Methods to prepare these compounds are described in C. A. May, Epoxy Resins: Chemistry and Technology, 2nd Edition, pp. 9-285 (1988). See also, for example, Japanese Patent Publications 50027,843 (1975), 53-042,298 (1978), 61-211,354 (1986), 61-241,322 (1986) and 61-241,343 (1986) and U.S. Pat. No. 4,879,329 which are incorporated herein by reference. Compounds of this type are commercially available as DER 542 and DER 511 brands of epoxy resin from The Dow Chemical Company; EPON™ 5354, 5201, 5203 and 5205 brands of brominated epoxy oligomers from Shell Chemical Company; and F-2000 and F-3000 series of brominated epoxy oligomers from Dead Sea Bromine Group.

Preferred brominated epoxy oligomers can be represented by the following formula:

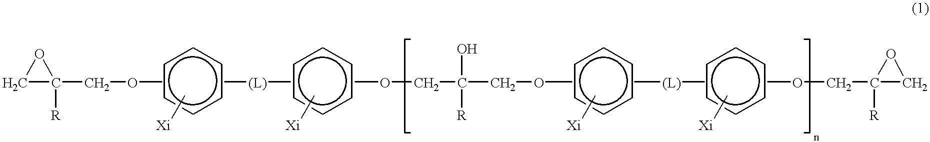

Where R can independently be hydrogen or an aliphatic hydrocarbyl group having from 1 to about 3 carbon atoms and is preferably hydrogen; X is independently chlorine or bromine and is preferably bromine in each occurrence; i is independently 1 or 2 and is preferably 2 in each occurrence; L is independently a divalent hydrocarbyl group having from 1 to about 6 carbon atoms, preferably 3 carbon atoms; and n can vary from 0 to 20 (not necessarily an integer) and is preferably 0 to about 6, more preferably 0 to about 4, even more preferably 0 to about 1.5, and most preferably 0 to about 0.5.

Preferred capped brominated epoxy oligomers can be represented by the following formula:

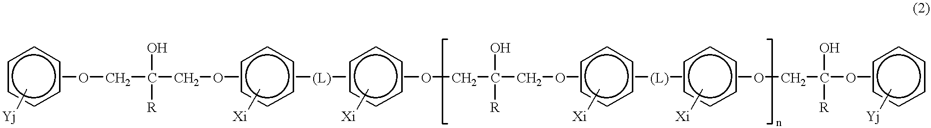

Where R can independently be hydrogen or an aliphatic hydrocarbyl group having from 1 to about 3 carbon atoms and is preferably hydrogen; X is independently chlorine or bromine and is preferably bromine in each occurrence; i is independently 1 or 2 and is preferably 2 in each occurrence; L is independently a divalent hydrocarbyl group having from 1 to about 6 carbon atoms, preferably 3 carbon atoms; n can vary from 0 to 20 (not necessarily an integer) and is preferably 0 to about 6, more preferably 0 to about 4, even more preferably 0 to about 1.5, and most preferably 0 to about 0.5; and Y is independently a hydrogen, an aliphatic hydrocarbyl group having from 1 to about 4 carbon atoms, chlorine or bromine and is preferably bromine in each occurrence; and j is independently 1 to about 5 in each occurrence, when Y is an aliphatic hydrocarbyl group j is preferably 2 and when Y is chlorine or bromine j is preferably 3.

A most preferred capped brominated epoxy oligomer is represented by the following formula: 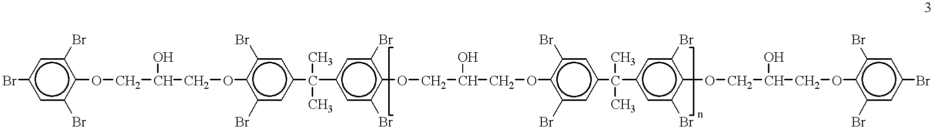 where n can vary from 0 to 20 (not necessarily an integer) and is preferably 0 to about 6, more preferably 0 to about 3.9, even more preferably 0 to about 1.3, and most preferably 0 to about 0.4.

In general, the flame retardant compound should be employed in at least about 1 weight percent, preferably at least about 5 weight percent, more preferably at least about 10 weight percent and most preferably at least about 15 weight percent based on the weight of the monovinylidene aromatic copolymer composition. Generally, the flame retardant compound is present in an amount less than or equal to about 40 weight percent, preferably equal to or less than about 30 weight percent, more preferably equal to or less than about 25 weight percent, even more preferably equal to or less than about 20 weight percent, even more preferably equal to or less than about 17 weight percent and most preferably equal to or less than about 15 weight percent based on the weight of the monovinylidene aromatic copolymer composition.

The monovinylidene aromatic copolymer composition may contain as component (c) a flame retardant synergist (enhancing agent) such as oxides and halides of groups IV-A and V-A of the periodic table; organic or inorganic compounds of phosphorous, nitrogen, boron or sulfur; and oxides and halides of, for example, zinc, magnesium and titanium, all disclosed in U.S. Pat. No. 4,016,139. Preferred enhancing agents in accordance with this invention are the oxides of antimony, arsenic and bismuth, with the oxides of antimony being especially preferred. Suitable synergists include Sb₂O₃ (antimony trioxide), Sb₂(CO₃)₃, Bi₂O₃ and Bi₂(CO₃) ₃. If present, the synergist is present in an amount equal to or greater than about 0.1 weight percent, preferably equal to or greater than about 0.5 weight percent, more preferably equal to or greater than about 1 weight percent, even more preferably equal to or greater than about 3 weight percent and most preferably equal to or greater than 5 weight percent based on the weight of the monovinylidene aromatic copolymer composition. Generally, the synergist is present in an amount equal to or less than about 25 weight percent, preferably equal to or less than about 15 weight percent, more preferably equal to or less than about 12 weight percent, even more preferably equal to or less than about 10 weight percent, even more preferably equal to or less than about 7 weight percent and most preferably equal to or less than about 5 weight percent based on the weight of the monovinylidene aromatic copolymer composition.

Component (d) is a drip suppressant such as a halogenated polyethylene, e.g., chlorinated polyethylene (CPE) or preferably a tetrafluoroethylene polymer. Suitable tetrafluoroethylene polymers for use in this invention are those adapted to form a fibril structure to stabilize the polymer under molten conditions. Such polymers are often referred to as PTFE or TEFLON™ and are generally disclosed for example by U.S. Pat. Nos. 3,005,795, 3,671,487 and 4,463,130, incorporated by reference herein. Most desirably the tetrafluoroethylene polymers have a high elastic memory. Any form of tetrafluoroethylene polymer can be used for this invention, preferably it is in solid particulate, powder, emulsion or latex form. Such tetrafluoroethylene polymers may be either a homopolymer or a copolymer of tetrafluoroethylene with another copolymerizable monomer wherein the tetrafluoroethylene is present as the major constituent in the copolymer, preferably at least at a level greater than 50 weight percent and more preferably at least at a level greater than 80 weight percent based on the weight of the tetrafluoroethylene copolymer. Some examples of tetrafluoroethylene polymers that have high elastic memory include TEFLON 6C, 60, 64, 6CN, 65 and 67 from DuPont Chemical Company.

The tetrafluoroethylene polymer is present in an amount equal to or greater than about 0.01 weight percent, preferably in an amount equal to or greater than about 0.02 weight percent, more preferably in an amount equal to or greater than about 0.05 weight percent, even more preferably in an amount equal to or greater than about 0.1 weight percent and most preferably in an amount equal to or greater than about 0.2 weight percent based on the weight of the monovinylidene aromatic copolymer composition. Generally, the tetrafluoroethylene polymer is present in an amount equal to or less than about 10 weight percent, preferably equal to or less than about 5 weight percent, more preferably equal to or less than about 2 weight percent, even more preferably equal to or less than about 1 weight percent, even more preferably equal to or less than about 0.5 weight percent and most preferably equal to or less than about 0.2 weight percent based on the weight of the monovinylidene aromatic copolymer composition.

In addition, the monovinylidene aromatic copolymer compositions may also optionally contain component (e) one or more additives that are commonly used in polymers of this type. Preferred additives of this type include, but are not limited to: antioxidants; impact modifiers; plasticizers, such as mineral oil; antistats; flow enhancers; mold releases; and fillers, such as calcium carbonate, talc, clay, mica, wollastonite, hollow glass beads, titaninum oxide, silica, carbon black, glass fiber, potassium titanate, single layers of a cation exchanging layered silicate material or mixtures thereof; etc. Further, compounds which stabilize monovinylidene aromatic copolymer compositions against degradation caused by, but not limited to heat, light, and oxygen, or a mixture thereof may be used.

If used, such additives may be present in an amount from at least about 0.01 percent by weight, preferably at least about 0.1 percent by weight, more preferably at least about 1 percent by weight, even more preferably at least about 2 percent by weight, and most preferably at least about 5 percent by weight based on the total weight of the monovinylidene aromatic copolymer composition. Generally, the additive is present in an amount less than or equal to about 25 percent by weight, preferably less than or equal to about 20 percent by weight, more preferably less than or equal to about 15 percent by weight, even more preferably less than or equal to about 12 percent by weight, and most preferably less than or equal to about 10 percent by weight based on the total weight of the monovinylidene aromatic copolymer composition.

Materials used to manufacture electronic equipment enclosures often are required to meet certain flammability requirements, for example resistance to ignition. There are many small scale tests which evaluate the flammability properties of materials such as polymers. Probably one of the most well known small scale flammability tests for ignition resistance is the Underwriter's Laboratories Standard 94 (UL 94) flammability test. As defined herein, a polymer composition receiving a rating of V-2, V-1, V-0 and/or 5V in the UL 94 test is considered ignition resistant.

The UL 94 vertical (V) flammability test determines the upward-burning characteristics of a solid. Five test specimens, of a desired thickness measuring 12.5 millimeter (mm) by 125 mm, suspended vertically over surgical cotton are ignited by a 18.75 mm Bunsen burner flame; two ignitions of 10 seconds each are applied to the samples. The rating criteria include the sum of after-flame times after each ignition, glow time after the second ignition, and whether the bar drips flaming particles that ignite the cotton. Table 1 lists the criteria for each V rating.

TABLE 1

| Rating* | V-2 | V-1 | V-0 |
|---|---|---|---|
| Max individual burn time | ≦30 | ≦30 | ≦10 |
| Burn time of 5 test specimens | ≦250 | ≦250 | ≦50 |
| Glow time after second ignition | ≦60 | ≦60 | ≦30 |
| Ignites cotton | Yes | No | No |

*Rating criteria are reported in seconds

The UL 94 5V flammability test utilizes a 125 mm Bunsen burner flame held at an angle of 20° to a test specimen, of a desired thickness measuring 12.5 mm by 125 mm, suspended vertically over surgical cotton, for 5 seconds, then away from it for 5 seconds, alternating in this pattern for five applications of the flame. After completion of the fifth ignition, the burning time must not exceed 60 seconds to achieve a 5V rating, nor can the cotton be ignited by flaming drips.

Preparation of the monovinylidene aromatic copolymer compositions of this invention can be accomplished by any suitable mixing means known in the art, including dry blending the individual components and subsequently melt mixing, either directly in the extruder used to make the finished article or pre-mixing in a separate extruder (e.g., a Banbury mixer). Dry blends of the compositions can also be directly injection molded without pre-melt mixing.

The monovinylidene aromatic copolymer compositions of this invention are thermoplastic. When softened or melted by the application of heat, the monovinylidene aromatic copolymer compositions of this invention can be formed or molded using conventional techniques such as compression molding, injection molding, gas assisted injection molding, calendering, vacuum forming, thermoforming, extrusion and/or blow molding, alone or in combination. The monovinylidene aromatic copolymer compositions can also be formed, spun, or drawn into films, fibers, multi-layer laminates or extruded sheets, or can be compounded with one or more organic or inorganic substances, on any machine suitable for such purpose. Some of the fabricated articles include instrument housings such as for power tools, appliances, consumer electronic equipment such as TVs, VCRs, web appliances, electronic books, etc., or information technology equipment such as telephones, computers, monitors, fax machines, battery chargers, scanners, copiers, printers, hand held computers, etc.

### EXAMPLES

To illustrate the practice of this invention, examples of preferred embodiments are set forth below. However, these examples do not in any manner restrict the scope of this invention.

The compositions of Comparative Example A and Examples 1 to 3 were prepared by mixing ABS pellets and other additives in a tumble blender for about 10 minutes. The dry blended mixture was fed to a 30 mm Werner and Pfleider fully intermeshing corotating twin screw extruder. The following conditions were used on the Werner and Pfleider extruder: all barrel temperature zones were set at 230° C. giving a melt temperature of 205° C. to 227° C.; RPMs were 200, torque was 70 to 80 percent, and the feed rate was 50 pounds per hour. The extrudate was cooled in the form of strands and comminuted as pellets. The pellets were dried in an air draft oven for 3 hours at 90° C. and then were used to prepare 1.6 mm and 3.2 mm thick test specimens on a 70 ton Arburg injection molding machine. The following conditions were used on the Arburg injection molding machine: all barrel temperature zones were at 230° C. giving a melt temperature of 225° C, injection pressure was 55 bar, holding pressure was 30 bar, back pressure was 10 bar, screw speed was 3.0, injection speed was 4.0, cycle time was 25 seconds, cooling time was 10 seconds, dosage was 13.1, and the mold temperature was 40° C.

The formulation content and properties of Comparative Example A and Examples 1 to 3 are given in Table 2 below in parts by weight of the total composition. In Table 2:

“ABS-M” is a mass polymerized ABS with about 19 percent acrylonitrile and about 10 percent polybutadiene rubber having a Vicat softening temperature of about 110° C. and a melt flow rate of 2.5 g/10 min. at 230° C. and an applied load of 3.8 kg;

“ABS-E” is an emulsion polymerized SAN grafted polybutadiene with about 45 percent rubber content;

“BEO” is a brominated epoxy oligomer available as EPON 5203 from Shell Chemical Company;

“Sb₂O₃” is antimony trioxide available as FIRESHIELD-H™ from Laurel Industries;

“TEFLON 6C” is a tetrafluoroethylene polymer commercially available from Du Pont Chemical Company; and

“IRGANOX™ 1076” is a phenolic antioxidant available from Ciba Geigy.

The following tests were run on Comparative Example A and Examples 1 to 3 and the results of these tests are shown in Table 2:

“UL 94” flammability test was performed on 1.6 mm and 3.2 mm test specimens;

“MFR” was determined according to ASTM D 1238 on a Tinius Olsen plastometer at 230° C. and an applied load of 3.8 kg.;

“Izod” impact resistance as measured by the Notched Izod test was determined according to ASTM D 256-90-B at 23° C. Specimens were cut from rectangular bars measuring 50.8 mm in length, 12.7 mm in width and 3.18 mm in thickness. The specimens were notched with a TMI 22-05 notcher to give a 0.254 mm radius notch. A 22 kilogram pendulum was used, values are reported in Joules per meter (J/m); and

“Tensile Properties” were determined in accordance with ASTM D 638. Tensile Type 1 test specimens were conditioned at 23° C. and 50 percent relative humidity 24 hours prior to testing. Testing was performed using an INSTRON 1125 mechanical tester. Tensile testing was performed at room temperature.

TABLE 2

| | Comparative | | | |
|---|---|---|---|---|
| | Example | | | |
| Example | A | 1 | 2 | 3 |
| Composition | | | | |
| ABS-M | 78.7 | 73.7 | 68.7 | 58.7 |
| ABS-E | 0 | 5 | 10 | 20 |
| BEO | 17 | 17 | 17 | 17 |
| Sb₂O₃ | 4 | 4 | 4 | 4 |
| TEFLON 6C | 0.1 | 0.1 | 0.1 | 0.1 |
| IRGANOX 1076 | 0.2 | 0.2 | 0.2 | 0.2 |
| Properties | | | | |
| UL 94 at 1.6 mm | V-0 | V-0 | V-0 | V-0 |
| UL 94 at 3.2 mm | 5V | 5V | 5V | 5V |
| MFR at 230° C./3.8 Kg, g/10 min | 5.6 | | | |
| Izod, J/m | 128 | 160 | 240 | 325 |
| Tensile Properties | | | | |
| Yield Strength, MPa | 41.3 | 40.9 | 38.6 | 36.5 |
| Break Strength, MPa | 35.1 | 34.2 | 33.6 | 2.6 |
| Break Elongation, % | 6 | 10 | 30 | 40 |

What is claimed is:

1. A monovinylidene aromatic copolymer composition comprising
(a) a combination of monovinylidene aromatic copolymers, the combination comprising:
(a1) a mass polymerized rubber-modified copolymer,
(a2) an emulsion polymerized rubber-modified copolymer and
(a3) optionally a monovinylidene aromatic copolymer;
(b) an effective amount of a flame retardant compound;
(c) optionally a synergist; and
(d) a drip suppressant,
wherein the monovinylidene aromatic polymer composition is rendered ignition resistant.

2. The monovinylidene aromatic copolymer composition of claim 1 wherein (b) the flame retardant compound is a bromine containing compound.

3. The monovinylidene aromatic copolymer composition of claim 1 wherein (b) the flame retardant compound is a brominated polycarbonate oligomer or a brominated epoxy oligomer.

4. The monovinylidene aromatic copolymer composition of claim 1 wherein (b) the flame retardant compound is represented by the formula: 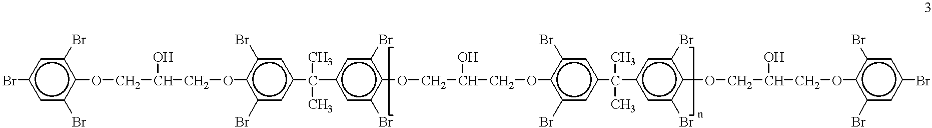
where the value for n is from 0 to about 3.9.

5. The monovinylidene aromatic copolymer composition of claim 1 wherein (d) the drip suppressant is a chlorinated polyethylene or a tetrafluoroethylene polymer.

6. The monovinylidene aromatic copolymer composition of claim 1 wherein (d) the drip suppressant is a powder or latex tetrafluoroethylene polymer.

7. The monovinylidene aromatic copolymer composition of claim 1 wherein (b) the flame retardant compound is present in an amount from about 1 to about 40 weight percent based on the weight of the monovinylidene aromatic copolymer composition.

8. The monovinylidene aromatic copolymer composition of claim 1 wherein (d) the drip suppressant is present in an amount from about 0.01 to about 10 weight percent based on the weight of the monovinylidene aromatic copolymer composition.

9. The monovinylidene aromatic copolymer composition of claim 1 wherein (c) the flame retardant synergist is present in an amount from 0 to about 25 weight percent based on the weight of the monovinylidene aromatic copolymer composition.

10. The monovinylidene aromatic copolymer composition of claim 9 wherein (c) the synergist is antimony trioxide (Sb₂O₃) present in an amount from about 0.1 to about 25 weight percent based on the weight of the monovinylidene aromatic copolymer composition.

11. The monovinylidene aromatic copolymer composition of claim 1 wherein (a) the combination of monovinylidene aromatic copolymers is present in an amount from about 50 to about 98.99 weight percent based on the weight of the monovinylidene aromatic copolymer composition.

12. The monovinylidene aromatic copolymer composition of claim 1 wherein
(a1) the mass polymerized rubber-modified copolymer is present in an amount from about 5 to about 95 weight percent,
(a2) the emulsion polymerized rubber-modified copolymer is present in an amount from about 95 to about 5 weight percent and
(a3) the monovinylidene aromatic copolymer is present in an amount from 0 to about 90 weight percent,
weight percents based on the combined weight of the monovinylidene aromatic copolymers (a1), (a2) and (a3).

13. A method for preparing a monovinylidene aromatic copolymer composition comprising the step of combining:
(a) a combination of monovinylidene aromatic copolymers, the combination comprising:
(a1) a mass polymerized rubber-modified copolymer,
(a2) an emulsion polymerized rubber-modified copolymer and
(a3) optionally a monovinylidene aromatic copolymer;
(b) an effective amount of a flame retardant compound;
(c) optionally a synergist; and
(d) a drip suppressant, wherein the monovinylidene aromatic polymer composition is rendered ignition resistant.

14. The method of claim 13 wherein the flame retardant compound is a brominated epoxy oligomer present in an amount from about 1 to about 40 weight percent, the synergist is antimony trioxide (Sb₂O₃) present in an amount from about 0.01 to about 25 weight percent and the drip suppressant is a tetrafluoroethylene polymer present in an amount from about 0.01 to about 10 weight percent based on the weight of the monovinylidene aromatic copolymer composition.

15. A method for producing a molded or extruded article of a monovinylidene aromatic copolymer composition comprising the steps of:
(A) preparing a monovinylidene aromatic copolymer composition comprising the step of combining:
(a) a combination of monovinylidene aromatic copolymers, the combination comprising:
(a1) a mass polymerized rubber-modified copolymer,
(a2) an emulsion polymerized rubber-modified copolymer and
(a3) optionally a monovinylidene aromatic copolymer;
(b) an effective amount of a flame retardant compound;
(c) optionally a synergist; and
(d) a drip suppressant,
wherein the monovinylidene aromatic polymer composition is rendered ignition resistant,
and
(B) molding or extruding said monovinylidene aromatic copolymer composition into a molded or extruded article.

16. The method of claim 15 wherein the molded or extruded article is selected from the group consisting of housings for power tools, appliances, TVs, VCRs, web appliances, electronic books, computers, monitors, fax machines, battery chargers, scanners, copiers, printers, or hand held computers.

17. The composition of claim 1 in the form of a molded or extruded article.

18. The molded or extruded article of claim 17 is selected from the group consisting of power tools, appliances, TVs, VCRs, web appliances, electronic books, computers, monitors, fax machines, battery chargers, scanners, copiers, printers, or hand held computers.
